(19) United States
(12) Patent Application Publication
(10) Pub. No.: US 2010/0036957 A1
(43) Pub. Date: Feb. 11, 2010

(54) Method and System for Implementing Transfer of a Network Session

(75) Inventors: Kant C. Patel, Fremont, CA (US); Feroz Alam Khan, Bangalore (IN); Karthik Rajan, Foster City, CA (US); Scot Mckinley, Belmont, CA (US)

Correspondence Address: ORACLE INTERNATIONAL CORPORATION;c/o VISTA IP LAW GROUP LLP, 1885 LUNDY AVENUE, SUITE 108, San Jose, CA, 95131, US

(73) Assignee: ORACLE INTERNATIONAL CORPORATION, Redwood Shores, CA (US)

(21) Appl. No.: 12/188,443

(22) Filed: Aug. 8, 2008

(51) Int. Cl. G06F 15/16

(52) U.S. Cl. 709/227

(57) ABSTRACT

An improved approach is described for sharing resources such as sessions and connections in database systems. Conduits and templates in shared memory can be employed to facilitate the transfer of network sessions. This provides a very efficient way to share processing entities across multiple users or clients.

### BACKGROUND AND SUMMARY

The invention is directed to an approach for implementing a transfer of a network session for database sessions.

A network session is the establishment of a communications channel from one location to another on a network. Network sessions are used for many purposes in the computing world. For example, a network session can be used to establish a database session.

A database session/connection is a heavyweight resource that corresponds to state on the database, e.g., for purposes of authentication, processing SQL statements, and other reasons for maintaining information about users or connections. It is typically considered very expensive in terms of computing resources to create and tear down a database session.

In addition to the computing costs to create and maintain a database connection, there is also an “opportunity cost” when assigning a database connection to a user or client (hereinafter collectively referred to as either “user” or “client”). This is because most computing/database platforms have a realistic limit on the number of simultaneous connections that can be created and assigned to users. As a result, if the limit of database connections has already been allocated to a first set of users, this may block another user from being able to establish a connection. This is particularly costly if the users that hold the connections are in a waiting or idle state, while there are other users that are ready to provide work but are prevented from doing so because the connections already being held by the idle user(s).

Therefore, it is often desirable to allow multiple users to share a session or connection. For example, consider when there are two users that are assigned to the same session or connection. It is highly unlikely that both users would consistently need to be actively using the session or connection. This is because the users would likely have numerous periods of waiting or idleness, e.g., while waiting for data, inputs, or processing. There, one approach for connection sharing is to statically assign multiple users to the same session or connection.

A more advanced form of sharing is to provide “pooling” of connections or sessions. Instead of statically assigning users to specific connections or sessions, a pool of connections or sessions is maintained, where each free session or free connection in the pool would be available to any user that is seeking a session or connection. Once the user has stopped using the session or connection, then that resource is released and allowed to be acquired by another user.

The present invention is directed to an improved approach for sharing resources such as sessions and connections in database systems. According to some embodiments, conduits and shared memory are employed to facilitate the transfer of network sessions. This provides a very efficient way to share processing entities across multiple users or clients. Other and additional objects, features, and advantages of the invention are described in the detailed description, figures, and claims.

### BRIEF DESCRIPTION OF FIGURES

FIG. 1 illustrates a flow of an n-tiered computing architecture.

FIG. 2 shows an example of a broker-server architecture.

FIG. 3 shows a flow of a method for performing connection/session sharing according to some embodiments of the invention.

FIG. 4 shows a flow of a method for performing forward hand-offs according to some embodiments of the invention.

FIGS. 5A-F illustrate a sequence of actions to perform connection establishment and forward hand-off according to some embodiments of the invention.

FIG. 6 shows a flow of a method for performing reverse hand-offs according to some embodiments of the invention.

FIGS. 7A-C illustrate a sequence of actions to perform reverse hand-off according to some embodiments of the invention.

FIG. 8 shows an architecture of an example computing system with which the invention may be implemented.

### DETAILED DESCRIPTION

The present approach is directed to a method, system, and computer readable medium for performing efficient bi-directional transfer of network sessions. Conduits and shared memory are employed to facilitate the transfer of network sessions. This provides a very efficient way to share processing entities across multiple users or clients.

For the purposes of illustration, embodiments of the present invention will be described with respect to the n-tiered computing architecture. It is noted however, that the present invention can be employed in any suitable computing architecture, such as the classic client-server architecture, and is therefore not to be limited to its use in the n-tiered architecture unless specifically claimed as such.

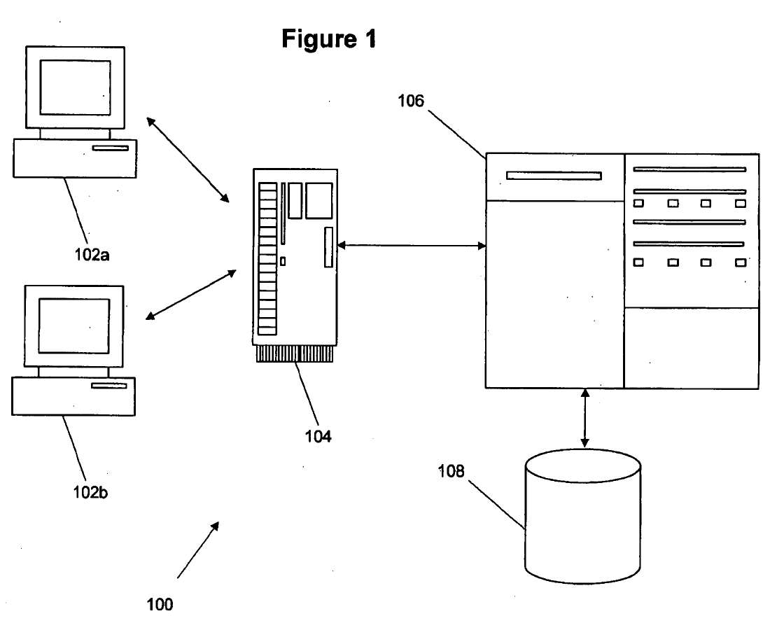

FIG. 1 provides an illustration of an example n-tiered computing system 100 with which the invention may be deployed. One or more users access the system 100 using client nodes 102a and 102b. The goal of the users at client nodes 102a and 102b is to access a database 108 that is managed by a database server 106 running a database management system (DBMS). One or more “middle tier” servers 104 handle the routing and forwarding of client requests and data between client nodes 102a/102b and the database server 106.

While embodiments of the present invention are directed to server-side connection pooling, it is noted that the middle tier server 104 can also be used to implement connection pooling so that multiple middle tier processing entities, such as threads, processes, or tasks, (hereinafter categorically referred to by example as “processes”) can share already opened connections and serially reuse them without having to create and tear down one for each client request.

Server side pooling may take place at database server 106 to handle resources such as sessions and threads of execution. For purposes of server side pooling in an n-tiered system 100, the direct “client” of the server process would be an entity at the middle tier server 104. By contrast, in a classic client-server architecture, the direct “client” of the server process could be the end-user client node 102a or 102b.

When a client side process needs a resource, it issues a request to the database server 106. This results in assignment of a dedicated resource from the pool to the client. The client then does the required work on the dedicated resource, and upon completion of the work or a period of inactivity, the resource is released back to the pool. At this point, a completely different client process on potentially a different client machine can reuse the same pooled resource. A suitable approach for implementing server-side pooling is described in co-pending U.S. application Ser. No. 12/047,278, filed on Mar. 12, 2008, which claims priority to Provisional Application No. 60/906,941, filed on Mar. 13, 2007, which are hereby incorporated by reference in their entirety.

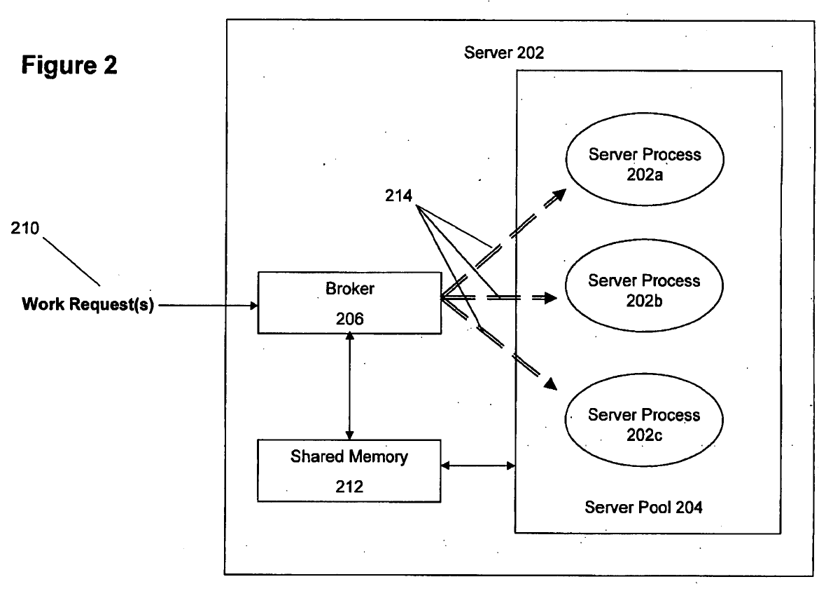

Some embodiments of the present invention utilize a broker-worker architecture to implement connection pooling. This architecture is shown in FIG. 2, in which the server 202 comprises a broker 206 and a server process pool 204. The server process pool 204 corresponds to a set of server processes 202a, 202b, and 202c to handle work on behalf of clients. The broker 206 communicates with the server processes 202a-c in the server pool 204 using one or more conduits 214. The server 202 also includes a shared memory space 212. The shared memory 212 is accessible by both the broker 206 and the server processes 202a-c.

The broker 206 is responsible for receiving initial incoming work requests 210 from clients. Once a free server process in the server pool 204 has been identified, then a hand-off occurs to transfer responsibility for servicing the work request 210 to the free server process. Therefore, to support extreme scalability with a multi-process server model, network sessions can be managed and handled efficiently between multiple processes. It is the process for performing this transfer of responsibility that is the subject of some embodiments of the invention.

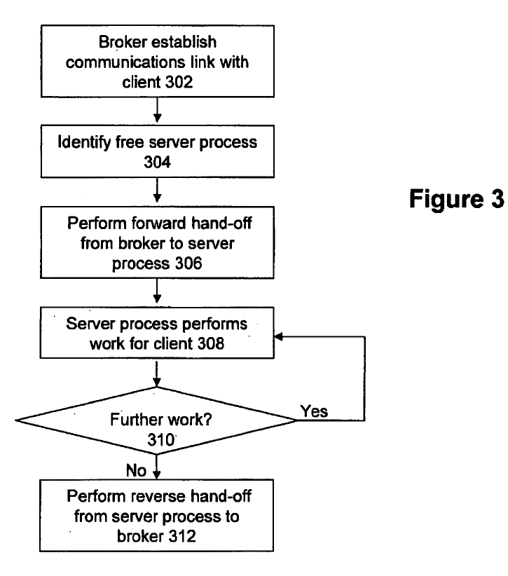

FIG. 3 shows a flowchart of a method for efficiently implementing pooling according to some embodiments of the invention, in which the process facilitates bi-directional transfers between the broker and the server process. At 302, the process begins when the client establishes a network session with the server/broker so that the broker is informed of a work request for the client. This establishment of a network session can occur in many appropriate ways depending upon the specific computing architecture and operating system that is being employed.

For example, for a UNIX-based system, the client establishes a connection to the server/broker by causing the creation of a socket descriptor to represent a network connection end-point. The socket descriptor is an operating system mechanism that essentially creates a bi-directional file descriptor for reading from and writing to a communications channel between two points, i.e., between the server and the client.

In addition to the socket descriptor used by an operating system, application-specific parameters and settings may need to be established or identified. For example, for a database application, the database network session may comprise connection specific state such as negotiated session options, session and service request details, user-level authentication, permissions, and profiles.

At 304, the broker identifies an available server process from within the server-side pool to handle the client work requests. Any suitable data structure can be employed within the server to maintain a list of free server processes. After the server process has been allocated to the client, the server process would then be removed from the list of available processes for the server pool.

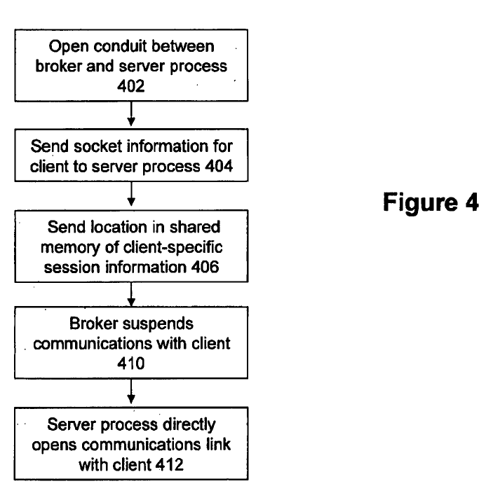

A forward hand-off is then performed, at 306, to transfer the network session from the broker to the server process. The specific details of the forward hand-off according to one embodiment are provided below with respect to the description of FIG. 4.

According to some embodiments, once hand-off has occurred, the broker is no longer actively communicating with the client. Instead, the client will directly communicate with the server process. This provides enormous performance improvements and facilitates high levels of scalability, since the broker is taken out of the direct communications chain between clients and server processes, thereby removing a significant bottleneck for communications.

At 308, the server process performs the requested work on behalf of the client. This continues until there is a determination made at 310 that no further work is to be immediately performed. This may occur, for example, if the client has no further work at all or if there is an idle period of no new work requests, where the idle period exceeds a designated threshold.

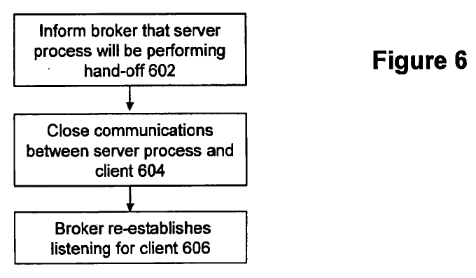

A reverse hand-off is performed, at 312, to transfer the network session from the server process back to the broker. The specific details of the reverse hand-off according to one embodiment are provided below with respect to the description of FIG. 6. After the hand-off, the broker monitors the network session for further activity. When activity/requests are detected on the session, the broker repeats the process of finding an idle/free server.

Reference is now made to FIG. 4, which describes a process for performing forward hand-offs from a broker process to a server process according to some embodiment of the invention. At 402, a conduit is opened between the broker and server processes. According to some embodiments, the conduit is only opened the first time the conduit is used—thereafter, the existing conduit is re-used for additional communications. The conduit can be any suitable inter-process communications (IPC) mechanism such as a socket or pipe. According to some embodiments, the available IPC mechanisms could differ depending upon the specific computing platform that is being employed. For example, it is possible that certain Unix-based platforms only use the socket mechanism as the conduit. For other platforms, any available IPC mechanism can be used, e.g., on the Microsoft Windows platform. At 404, sufficient session state information is communicated such that the server process is given a connection to the client. For example, the socket descriptor for the network session established for the client is communicated to the server process via the conduit.

The server process will also receive the application-specific parameters and settings for the client, such as negotiated session options, session and service request details, user-level authentication, permissions, and profiles. According to some embodiments, a template-based approach is used to transfer this information. A named template representing these session characteristics is created and stored into the shared memory, and is accessible to all server processes. This approach, at 406, allows the broker to just send the template name or a pointer to the template in shared memory, rather than transferring the details of that information using IPC calls, thereby saving on the transfer costs for the network session state. With the template name or pointer, the server process can perform direct memory access to obtain that application-specific information.

Therefore, this generally allows all future network sessions to be clubbed into a template based on client tagging, or based on session characteristic comparison. The template approach also provides efficiencies based on the fact that most database connection requests originate from a few middle-tier clients. These client requests are typically identical, with similar network negotiated session options and characteristics.

Once hand-off has occurred, then at 410, the communications link between the client and broker will be suspended. It is noted that the broker does not completely remove its references to the network session, e.g., it will maintain the connection and session information along with session state information. The broker process will continue to maintain a reference to the socket descriptor for the client network session. Therefore, the link is merely “suspended” rather than being deleted since the broker still has access to the socket descriptor, but will avoid actively listening or writing data to the socket descriptor. In effect, the broker process ensures that the socket descriptor is dormant so that no activity will be initiated on it until it is received back through a reverse hand-off, as described in more detail below.

Once the hand-off has occurred, then at 412, the server process will directly communicate with the client. Since the server process will be directly accessing the socket descriptor, this means that no communications between the server and the client will need to be transferred through the broker.

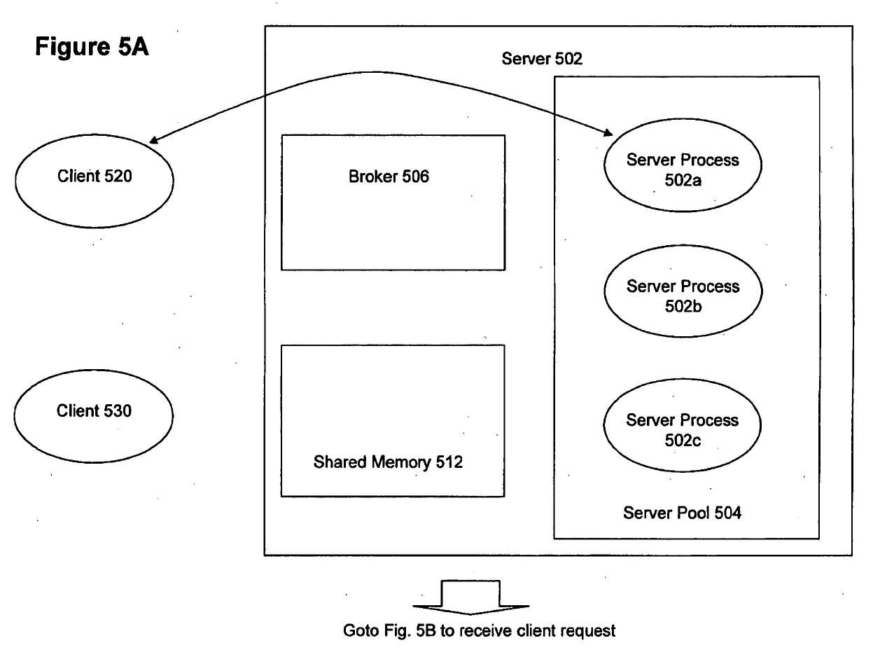

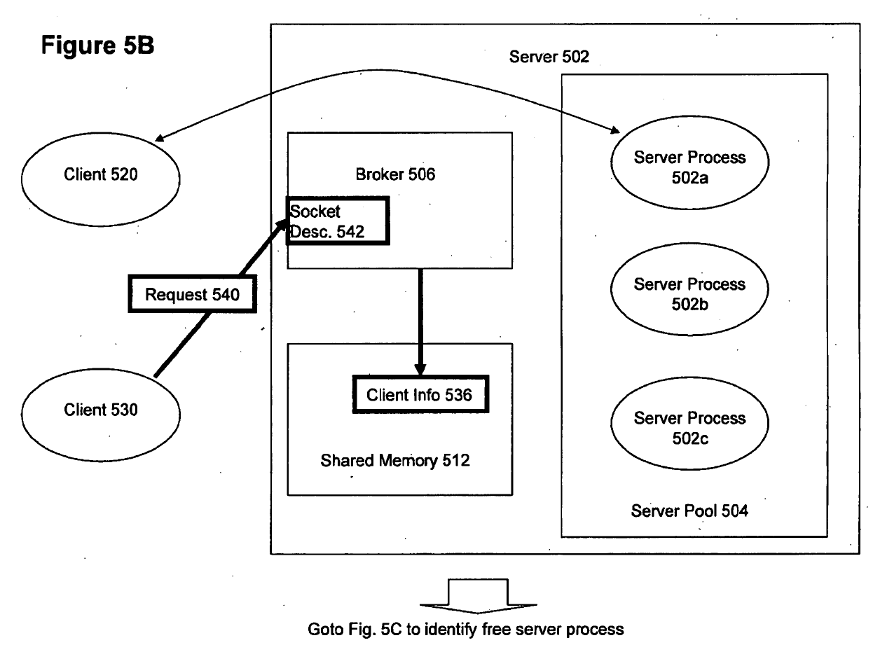

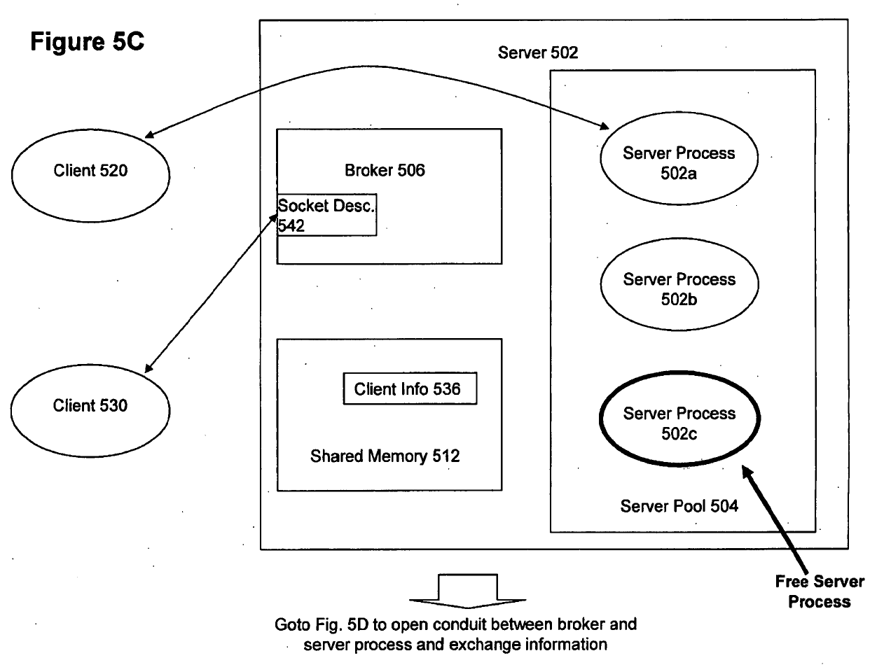

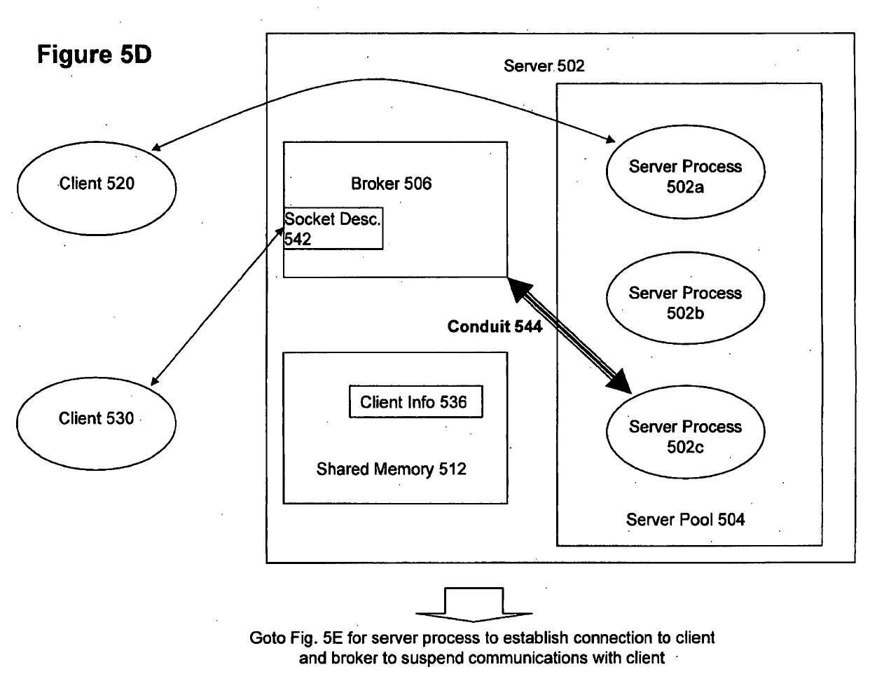

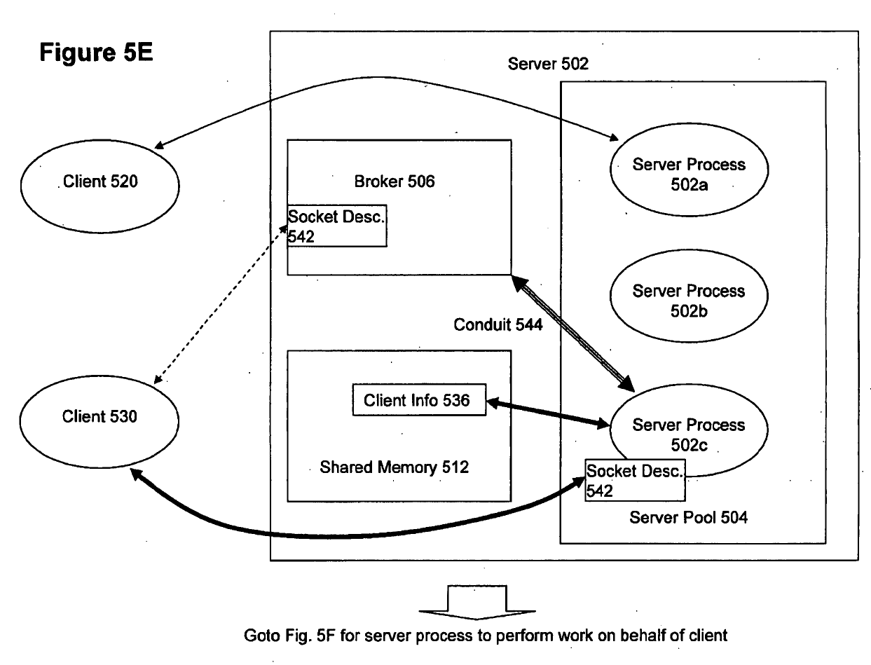

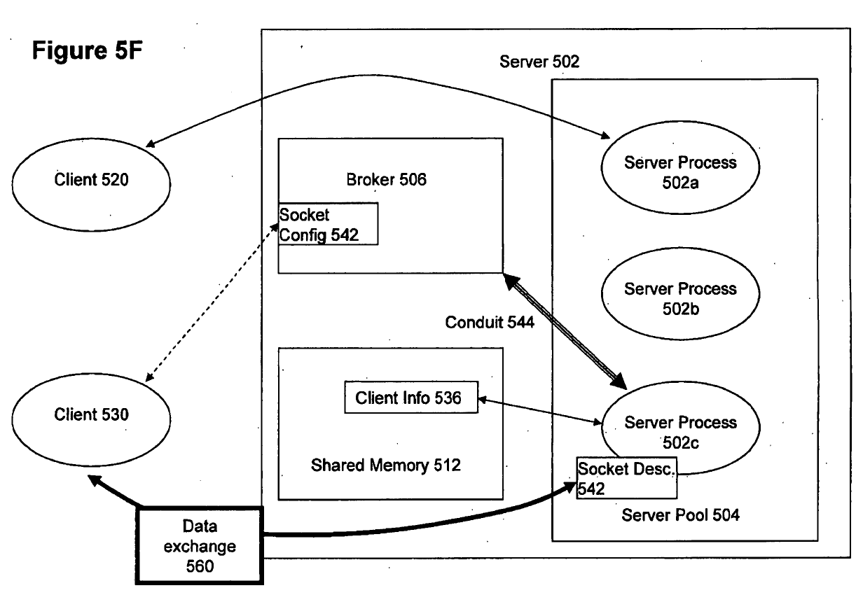

FIGS. 5A-F provide an illustration of the method and system for initiating a network session and performing a hand-off according to this embodiment of the invention. FIG. 5A shows an initial state of the system having clients 520 and 530 and a server 502. Server 502 comprises a broker process 506 and a server pool 504 containing server processes 502a, 502b, and 502c. Server 502 also includes a shared memory 512 that is accessible by the broker process 506 and the server processes 502a-c within server pool 504. In this initial state, client 520 is already being serviced by server process 502a.

FIG. 5B shows the sequence of events when client 530 initiates a client request 540 to the server. The server 502 establishes a network connection, with the socket descriptor 542 being the handle to the new network connection. The broker 506 uses the socket descriptor 542 to communicate with client 530. In addition, a template 536 within shared memory 512 is populated with the client's application specific data and parameters.

Referring to FIG. 5C, this figure illustrates the selection of a free server process to handle the requests from client 530. In this example, server pool 504 contains three server processes 502a, 502b, and 502c. Server process 502a is already busy servicing requests for another client 520. Therefore, server process 502a is not eligible to be selected by broker 506 to service client 530. Instead, broker 506 must choose from between process 502b or 502c to handle the work requests from client 530. In this example, it is assumed that server process 502c has been chosen to service client 530, e.g., because it is at the top of a list of free server processes that is being maintained for the server pool 504 and it matches the session characteristics as required by client 530. In one embodiment, the template 536 can be used to optimize this selection.

Next, as shown in FIG. 5D, a conduit 544 is opened between broker 506 and the selected server process 502c. Any suitable IPC mechanism, such as a socket, can be employed as the conduit 544. The conduit 544 essentially acts as the mechanism for a server process to listen to incoming requests from the broker 506. Therefore, the broker 506 needs to identify or create the specific conduit associated with server process 502c to communicate with that server process.

The items of connection or session information needed for the forward hand-off are passed from the broker 506.to the server process 502c via the conduit 544 as an IPC message. For instance, information regarding the socket descriptor 542 is passed to the server process 502c through the conduit 544. In addition, the name or address of the template 536 is also passed to the server process 502c via the conduit 544.

Once the server process 502c has sufficient data to complete the hand-off, then as shown in FIG. 5E, the server process 502c will establish a communications connection to the client. This is accomplished by having the server process 502c use the socket descriptor 542 to directly communicate with the client 530. The server process 502c will also access the template 536 in the shared memory 512 to obtain the application-specific information to perform database processing.

The broker 506 will also suspend its communications with the client 530. It is noted that the broker 506 is merely suspending its communications with client 530, rather than completely severing the communications link. This is accomplished by the broker maintaining its session and/or connection information for the client 530, e.g., including maintaining its reference to the socket descriptor 542.

Thereafter, as shown in FIG. 5F, the server process 502c will directly communicate with client 530 to perform work on behalf of the client 530. Data exchanges 560 between the client 530 and the server process 502c will occur without having to go through the broker 506.

FIG. 6 describes a method for performing a “handback”, also referred to as a reverse hand-off from the server process back to the broker process. The reverse hand-off will be performed once it is determined that there is no further work to be immediately performed by the server process on behalf of the client. For example, the server process may be configured to check whether there is a period of inactivity that exceeds a certain threshold. The occurrence of the inactivity period would trigger the reverse hand-off process.

The reverse hand-off is performed to transfer the network session from the server process back to the broker. At 602, the server process communicates with the broker to inform the broker of the handback. Given that the broker process still has all the session state for the client (including the socket descriptor), this process is extremely efficient. The server process only needs to indicate which network session it is handling back. No other transfer takes place according to this embodiment.

At 604, the server process then terminates its communications link to the client. This is accomplished by removing the session state; including the socket descriptor information, from the server process. The server process is then placed back on the list of free processes and is available to be selected to service another client.

After the hand-off, at 606, the broker resumes monitoring of the network session for the client for further activity. When activity/requests are detected on the session, the broker repeats the process of finding an idle/free server.

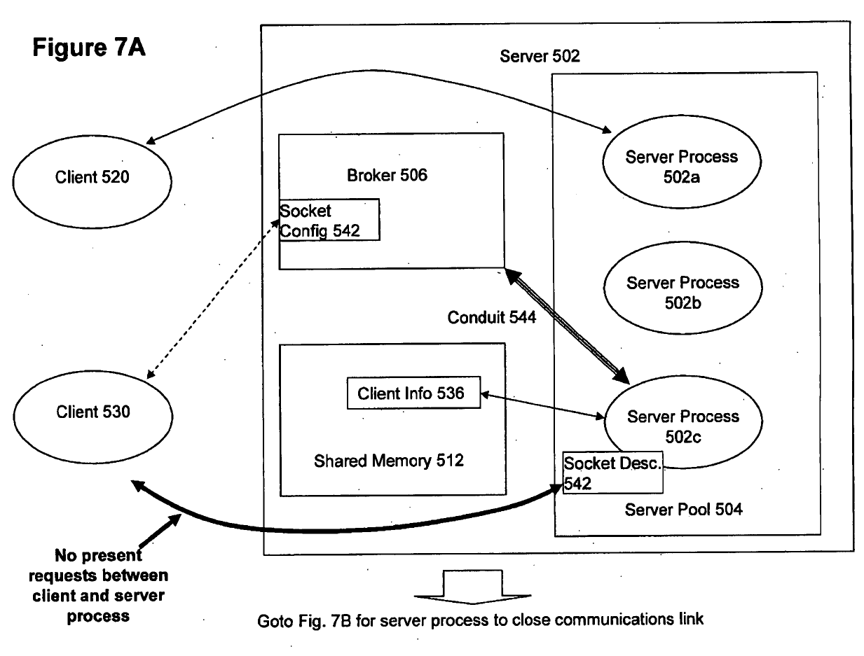

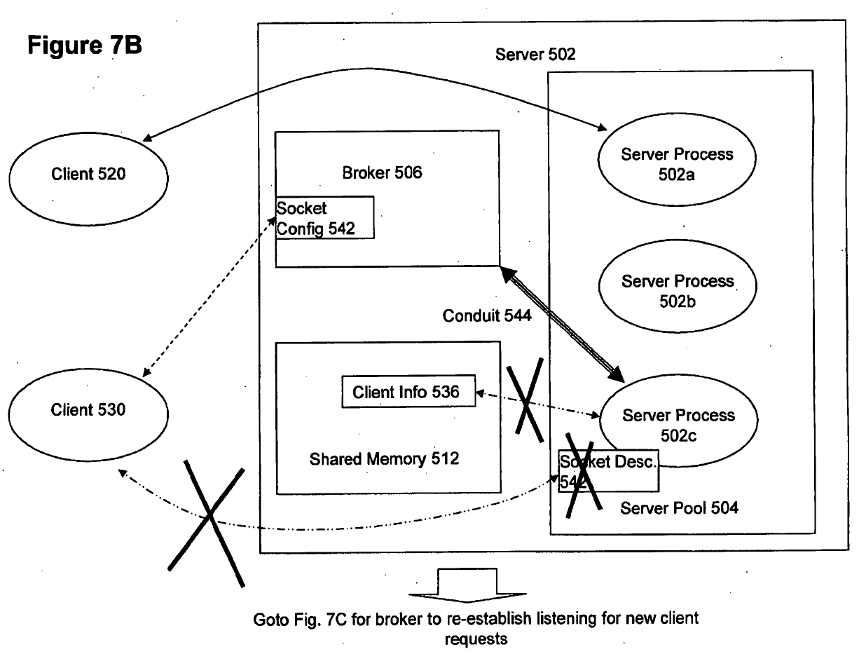

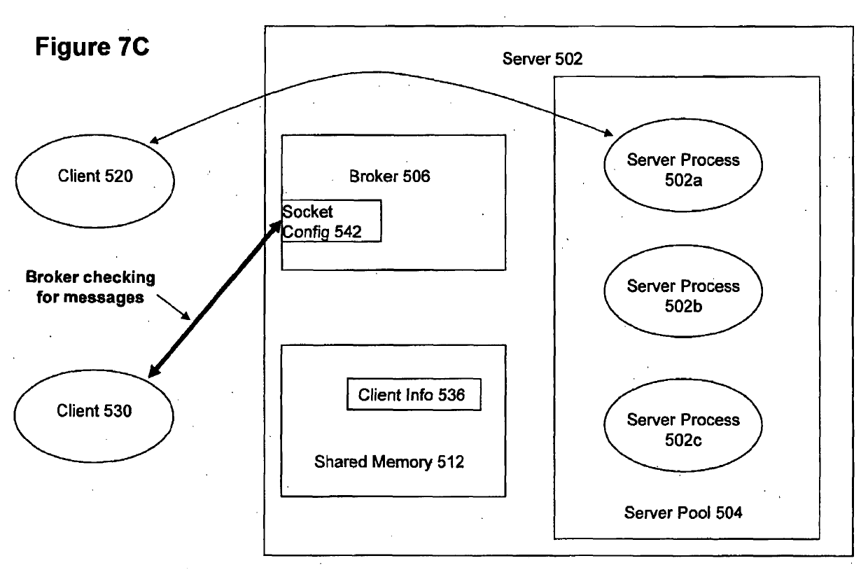

FIGS. 7A-C illustrate this process of performing a reverse hand-off. FIG. 7A continues from state shown in FIG. 5F. Recall that FIG. 5F shows the server process 502c performing work on behalf of client 530. FIG. 7A is at a later point in time after server process 502c has completed the requested work for client 530. At this point, there are no present requests for work from client 530, and the designated time-out period has elapsed.

FIG. 7B shows the termination of the communications link between server process 502c and the client 530. In particular, the session state for the client 530 will be

As shown in FIG. 7C, the broker 506 will re-establish is monitoring of requests from client 530. In effect, broker 506 will re-reference the session state for the network connection to client 530.

Therefore, what has been described is a very advanced and efficient approach for effecting transfers of network sessions to implement connection pooling. The forward handoff is extremely optimized due to a variety of factors, including the use of a template in shared memory to reduce communications requirements for the hand-off. In the reverse direction, the maintenance of session state at the broker also optimizes and increases the efficiency of the handback.

Efficient bi-directional session transfers can be therefore be used to implement highly scalable servers. Its use with server side connection pooling allows the database to handle an order of magnitude more client requests with the same hardware.

Past solutions that deal with this scalability issue have not been efficient as most approaches involve session or connection pooling on the client-side, whereas the server side still has to maintain a session for each client connection

### System Architecture Overview

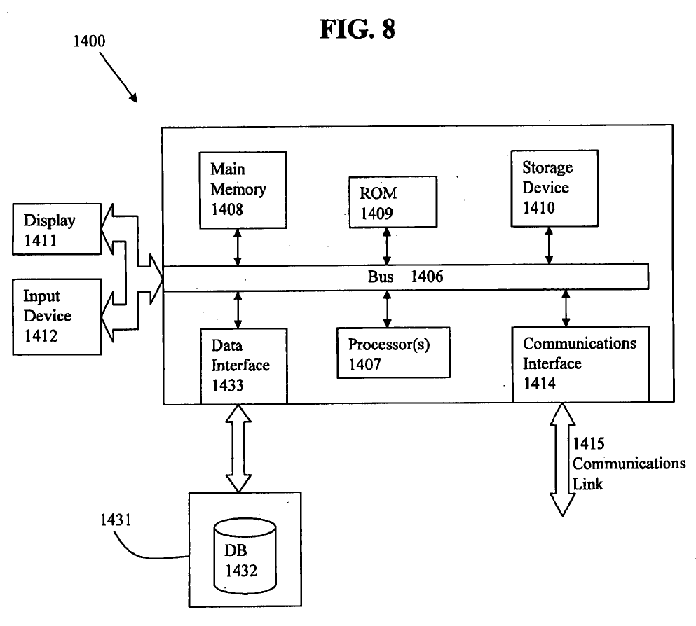

FIG. 8 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A method for performing a transfer of a network connection in a server, comprising:
establishing a network connection between a client and a database server, where the database server comprises a broker and one or more processing entities;
receiving a request at the broker with respect to work to be performed for the client;
identifying a processing entity to handle the work for the client;
transferring the network connection from the broker to the processing entity so that the processing entity will perform work for the client, and wherein the processing entity and the client will communicate without passing messages through the broker, and
upon determining that processing entity is to not perform any further immediate work for the client, then transferring the network connection from the processing entity to the broker.

2. The method of claim 1 in which the network connection is transferred from the broker to the processing entity by opening a conduit between the broker and the processing entity, where connection information is passed from the broker to the conduit.

3. The method of claim 2 in which the conduit is implemented as an inter-process communications (IPC) mechanism.

4. The method of claim 2 in which the connection information comprises a socket descriptor and the processing entity uses the socket descriptor to communicate with the client.

5. The method of claim 2 in which the connection information comprises a pointer to a portion of shared memory that comprises information about the client or the network connection, the shared memory accessible by both the broker and the processing entity.

6. The method of claim 5 in which the portion of shared memory is structured as a template.

7. The method of claim 6 in which the template is a named template, where the pointer comprises a name for the named template.

8. The method of claim 6 in which the portion of shared memory comprises authentication information, profile information, user information, application-specific information, or database-specific information.

9. The method of claim 6 in which a format of the template is used for multiple clients.

10. The method of claim 1 in which the broker maintains connection state information even after transferring the network connection to the processing entity.

11. The method of claim 10 in which the act of transferring the network connection from the processing entity to the broker is performed by the broker re-accessing the connection state information.

12. The method of claim 10 in which the connection state information comprises a socket descriptor.

13. The method of claim 1 in which the client is an entity located in a middle-tier server in an n-tiered architecture.

14. The method of claim 1 in which the broker performs listening for work requests after the network connection is transferred from the processing entity to the broker.

15. The method of claim 1 in which the processing entity is assigned to another client after the network connection is transferred from the processing entity to the broker.

16. The method of claim 1 in which the one or more processing entities are within a pool of processing entities.

17. A system for performing a transfer of a network connection in a server, comprising:
a memory for holding program code having program instructions;
a processor for executing the program instructions, wherein the program instructions comprises establishing a network connection between a client and a server, where the server comprises a broker and one or more processing entities; the program instructions comprise receiving a request at the broker with respect to work to be performed for the client; the program instructions comprise identifying a processing entity to handle the work for the client; the program instructions comprise transferring the network connection from the broker to the processing entity so that the processing entity will perform work for the client, and wherein the processing entity and the client will communicate without passing messages through the broker; and the program instructions comprise upon determining that processing entity is to not perform any further immediate work for the client, then transferring the network connection from the processing entity to the broker.

18. The system of claim 17 in which the network connection is transferred from the broker to the processing entity by opening a conduit between the broker and the processing entity, where connection information is passed from the broker to the conduit.

19. The system of claim 18 in which the connection information comprises a socket descriptor and the processing entity uses the socket descriptor to communicate with the client.

20. The system of claim 18 in which the connection information comprises a pointer to a portion of shared memory that comprises information about the client or the network connection, the shared memory being accessible by both the broker and the processing entity.

21. The system of claim 20 in which the portion of shared memory is structured as a template.

22. The system of claim 20 in which the portion of shared memory comprises authentication information, profile information, user information, application-specific information, or database-specific information.

23. The system of claim 17 in which the broker maintains connection state information even after transferring the network connection to the processing entity.

24. The system of claim 23 in which the act of transferring the network connection from the processing entity to the broker is performed by the broker re-accessing the connection state information.

25. The system of claim 17 in which the client is an entity located in a middle-tier server in an n-tiered architecture, and the server comprises a database server.

26. The system of claim 17 in which the broker perform listening for work requests after the network connection is transferred from the processing entity to the broker.

27. A computer program product that includes a computer readable medium, the computer readable medium comprising a plurality of computer instructions which, when executed by a processor, cause the processor to execute performing a process for performing a transfer of a network connection in a server, the process comprising:
establishing a network connection between a client and a server, where the server comprises a broker and one or more processing entities;
receiving a request at the broker with respect to work to be performed for the client;
identifying a processing entity to handle the work for the client;
transferring the network connection from the broker to the processing entity so that the processing entity will perform work for the client, and wherein the processing entity and the client will communicate without passing messages through the broker; and
upon determining that processing entity is to not perform any further immediate work for the client, then transferring the network connection from the processing entity to the broker.

28. The computer program product of claim 27 in which the network connection is transferred from the broker to the processing entity by opening a conduit between the broker and the processing entity.

29. The computer program product of claim 28 in which the connection information comprises a socket descriptor and the processing entity uses the socket descriptor to communicate with the client.

30. The computer program product of claim 28 in which the connection information comprises a pointer to a portion of shared memory that comprises information about the client or the network connection, the shared memory accessible by both the broker and the processing entity.

31. The computer program product of claim 30 in which the portion of shared memory is structured as a template.

32. The computer program product of claim 30 in which the portion of shared memory comprises authentication information, profile information, user information, application-specific information, or database-specific information.

33. The computer program product of claim 27 in which the broker maintains connection state information even after transferring the network connection to the processing entity.

34. The computer program product of claim 33 in which the act of transferring the network connection from the processing entity to the broker is performed by the broker re-accessing the connection state information.
